(19) United States
(12) Patent Application Publication
(10) Pub. No.: US 2025/0206195 A1
(43) Pub. Date: Jun. 26, 2025

(54) Device for Recognizing Living Beings in a Vehicle Interior

(71) Applicant: HELLA GMBH & CO. KGAA, Lippstadt (DE)

(72) Inventors: Belal Abu Suheil, Lippstadt (DE); Joerg Schrape, Lippstadt (DE)

(21) Appl. No.: 18/989,273

(22) Filed: Dec. 20, 2024

(30) Foreign Application Priority Data
Dec. 20, 2023 (DE) 102023136076.0

(51) Int. Cl. B60N 2/00

(52) U.S. Cl. CPC B60N 2/0035; B60N 2/0024

(57) ABSTRACT

A device for recognizing living beings, in particular persons and/or children, in a vehicle interior of a vehicle, having: a first antenna for transmitting and/or receiving ultra-wideband waves; a second antenna for transmitting and/or receiving ultra-wideband waves; a lower conductor structure, wherein the first antenna and the second antenna are arranged at least partially in the lower conductor structure; and an upper conductor structure, wherein the first antenna and the second antenna are arranged at least partially in the upper conductor structure. Furthermore, the invention relates to a corresponding method, a computer program product, a computer-readable data carrier, a control unit, and a vehicle.

### CROSS-REFERENCE TO RELATED APPLICATIONS

The present application claims the benefit of German Patent Application No. 10-2023-136-076.0, filed Dec. 20, 2023, the disclosure of which is incorporated by reference.

### BACKGROUND OF THE INVENTION

The invention relates to a device with the features of the independent device claim, a method with the features of the independent method claim, a computer program product with the features of the independent patent claim relating to a computer program product, a computer-readable data carrier with the features of the independent patent claim relating to a computer-readable data carrier, a control unit with the features of the independent patent claim relating to a control unit and a vehicle with the features of the independent patent claim relating to a vehicle.

Antennas and methods for ultra-wideband (UWB) are well known. They can be used in vehicles for transferring, in particular transmitting and/or receiving, for example control signals for vehicle access. Here, for example, frequencies of (about) 6 GHz to 8 GHz are used. The so-called “child presence detection” in vehicles is also well-known. Here, for example, frequencies of (about) 60 GHz are used. These are devices or methods for recognizing persons and/or children who have been (unintentionally) left behind in a vehicle, for example. More generally, they can be used for recognizing living beings in general, for example including adults (senior citizens) and/or animals. Particularly at high ambient temperatures, leaving behind living beings such as humans or animals can be very dangerous. Children, in particular newborns and infants, may be at particular risk.

However, the known state of the art methods and systems have various disadvantages. For example, they cannot reliably recognize living beings, in particular in the interior of vehicles. Known devices and/or methods may be too large, too heavy, too expensive, too power-intensive (in particular with regard to current and/or voltage requirements) and/or too complicated. They can have (excessively) large antennas or antenna arrays comprising voluminous antenna structures. High supply currents (e.g. in the order of 2 amps) may be required. For example, a (comparatively) high directivity is required, in particular for half-space radiating antennas (e.g. patch antennas). Corresponding arrays may require at least two half-space radiating antennas, in particular to achieve a directional effect and/or to provide information on the direction of the target and/or to reduce path losses to the target. Furthermore, the required patch antennas cannot be realized in the bandwidth required for function on cost-effective standard printed circuit base materials (e.g. FR4), in particular in standard thickness 1.5 mm. Furthermore, directional antennas radiating on one side, in particular in the case of monostatic radar (wherein in particular one antenna is transmitting and the same antenna is receiving) can be disadvantageous if the direct connection between the antenna and the moving living being, in particular the chest, is e.g. shadowed by the living being, such as the head of a child, and in particular the reflected signal no longer contains any (or insufficient, e.g. due to too low a level) information about the respiratory movement. In the case of bistatic radar (wherein, in particular, one antenna is transmitting and another, e.g. in a second control unit, is receiving), it may be necessary to align the involved directional antennas radiating on one side with the target for optimum function. As the position and/or orientation of the living being in the vehicle can be very variable, the alignment of the antennas can only be optimized to a very limited extent. Using 60 GHz may require the use of one or more control units, heavy, large and/or cost-intensive hardware.

It is therefore an object of the present invention to at least partially overcome at least one of the disadvantages described above. In particular, it is the object of the invention to enable an improved device and method for recognizing living beings, in particular persons and/or children, in a vehicle interior.

### SUMMARY OF THE INVENTION

The above object is achieved by a device with the features of the independent device claim, a method with the features of the independent method claim, a computer program product with the features of the independent patent claim relating to a computer program product, a computer-readable data carrier with the features of the independent patent claim relating to a computer-readable data carrier, a control unit with the features of the independent patent claim relating to a control unit and a vehicle with the features of the independent patent claim relating to a vehicle. Further features and details of the invention are apparent from the subclaims, the description and the drawings. Here, features and details described in connection with the device according to the invention of course also apply in connection with the method according to the invention and/or in connection with the computer program product according to the invention and/or in connection with the computer-readable data carrier according to the invention and/or in connection with the control unit according to the invention and/or in connection with the vehicle according to the invention and vice versa, so that with regard to the disclosure reference is or can always be made reciprocally to the individual aspects of the invention. In particular, advantages described in the first, second, third, fourth, fifth and/or sixth aspect also apply to the first, second, third, fourth, fifth and/or sixth aspect, respectively.

The above object is achieved according to a first aspect by a device for recognizing living beings, in particular persons and/or children, in a vehicle interior of a vehicle, having:
a first antenna for transmitting and/or receiving ultra-wideband waves, a second antenna for transmitting and/or receiving ultra-wideband waves,
a lower conductor structure, wherein the first antenna and the second antenna are at least partially arranged in the lower conductor structure,
an upper conductor structure, wherein the first antenna and the second antenna are at least partially arranged in the upper conductor structure.

Here, the first and second antenna can preferably be designed as transmit/receive antenna, i.e. in particular they can be used for both transmitting and receiving. It may be provided that the first antenna is used for transmitting (in particular as a transmit antenna) and the second antenna for receiving (in particular as a receive antenna). A switch is also conceivable (see below). Here, the first and/or second antenna are tuned and/or adapted for ultra-wideband frequencies (UWB). Here, in particular, tuning can be carried out via dimensioning in or by an upper and/or lower conductor structure, in particular via a printed circuit board. It can thus be provided to enable production, adaptation and/or tuning during the production of the printed circuit board. This can reduce costs and/or effort.

Here, the first and second antenna can preferably be configured to detect the presence of a living being in a vehicle interior by transmitting and/or receiving ultra-wideband waves. If a living being is in the vicinity of the first and/or second antenna, in particular in the vehicle interior, the living being influences the transmitted and/or reflected ultra-wideband waves (in particular through impedance changes, changes in the polarization type or direction, changes in the phase position, absorption and/or reflection). Here, the received signal can therefore have signals and/or frequencies, in particular a movement frequency (such as preferably the respiratory frequency). Alternatively or additionally, it may also be possible to infer the shape, size, age and species (e.g. human/animal, adult/child) of the living being depending on its size, volume, physical proportions and/or impedance (in particular impedance distribution).

Here, the first and/or second antenna can be designed depending on the vehicle, in particular its size and/or arrangement of conductive components, the frequency, the distance between the upper and lower printed circuit board and/or a substrate located between the upper and lower printed circuit board (in particular its material and/or thickness).

The ultra-wideband waves can be absorbed and/or reflected on the vehicle, in particular the electrically conductive components of the vehicle, in particular comprising a change in the type or direction of polarization. Here, reflections can preferably be used to detect living beings. Preferably, the first and/or second antenna are configured to detect at least one reflection, preferably many reflections of the transmitted waves, and in particular to enable a movement frequency (e.g. respiratory frequency) to be determined as a function of the reflections. By arranging the antennas in a lower and/or upper conductor structure, a larger proportion of reflected ultra-wideband waves can be received.

Here, the lower conductor structure can be facing away from the vehicle interior. Here, the upper conductor structure can be facing the vehicle interior (or vice versa). The (geometric) arrangement and/or design of the first and/or second antenna can be used to realize an omnidirectional antenna which, in particular, covers a (comparatively) larger solid angle and/or generates one or more reflections. More and/or stronger reflections (and/or echoes) can be generated, in particular from different directions, for example by reflections on the vehicle body and/or electrically conductive objects, which preferably enables a wider and/or more homogeneous illumination of the vehicle interior. In particular, this can result in advantages over antennas with (pronounced) directional characteristics. This enables a detection, in particular determining a movement frequency, regardless of the (exact) position of the living being. The device according to the invention can therefore be more robust and, in particular, less susceptible to faults and/or errors. This prevents a situation in which it is not possible to recognize a living being, even though there is a living being in the vehicle interior. Furthermore, the device, in particular through the use of omnidirectional antennas, can enable lower path losses, preferably in bistatic operation, in particular since the first and/or second antenna can, in addition to the movement frequencies in the immediate vicinity, e.g. from an adjacent and/or assigned row of seats, also receive movement frequencies from more distant areas, e.g. other rows of seats. This can significantly increase the robustness of the recognition of living beings.

In the context of the invention, it may be advantageous that the first antenna has a first polarization (type or direction) and the second antenna has a second polarization (type or direction), wherein in particular the first polarization and the second polarization are at least partially different.

Preferably, the first and second polarization (type or direction) are completely different and/or have as little or no correspondence as possible. In other words, they can be designed to complement one another. This advantageously enables improved detection, which makes it possible to recognize living beings in (almost) all theoretically and/or practically conceivable constellations. This allows the robustness to be optimized. Here, it may be provided that the first and second polarization differ at least in sections (in terms of time), in particular for most of the time. Here, the first and/or second polarization can be determined (or predetermined) by the geometric design of the first and/or second antenna.

In the context of the invention, it is conceivable that the first antenna has a first polarization comprising a linear polarization and/or that the second antenna has a second polarization comprising a circular polarization.

This enables a particularly reliable different polarization (type or direction) of the first and second antenna. For example, a transmission with a linear polarization by the first antenna, in particular (virtually) independently of the reflection (in which, in particular, the polarization type and/or direction can change (several times)), can in any case be received by the second antenna, which can have a circular polarization. This can (additionally) increase robustness.

Alternatively or additionally, the first and/or second antenna can have a circular or elliptical polarization.

In the context of the invention, it may be provided that the first antenna and/or the second antenna is/are configured to carry out transmitting and/or receiving at a frequency between 1.00 GHz to 100.00 GHz, in particular between 5.00 GHz to 10.00 GHz, preferably between 6.25 GHz to 8.25 GHz, preferably between 7.75 GHz to 8.25 GHz, particularly preferably between 7.65 GHz to 7.85 GHZ, ideally between 7.70 GHz to 7.80 GHz.

Here, the above frequency range can be advantageous in order to use hardware and/or semiconductors that function on this frequency or are optimized for it.

Here, ultra-wideband waves may comprise electromagnetic fields that lie within the above-mentioned frequency range. Here, transmitting and/or receiving can be carried out in the above frequency ranges. The reflections can also lie (essentially) in the above frequency ranges. This means that the first and/or second antenna can advantageously be used for transmitting and receiving (“transmit/receive” or “Tx/Rx”).

It is also conceivable that the lower conductor structure and/or upper conductor structure has at least one decoupling slot in order to decouple the first antenna, the second antenna and/or a ground plane.

Here, a decoupling slot can have a separation between the first and/or second antenna and/or the ground plane in the upper and/or lower conductor structure. Here, the material of the conductor structure can be removed. Thus, no galvanic conductive connection can occur at or in the decoupling slot. Overcoupling of electromagnetic fields, in particular in the UWB range, can also be prevented or at least reduced. This allows the coupling to be reduced.

The first and/or second antenna may exhibit coupling (in particular “crosstalk”), in particular due to their tuning and/or adaptation to the same frequency (UWB). Here, the at least one decoupling slot may be designed such that it reduces the coupling between the first and second antenna and/or to the ground plane. This allows decoupling to be improved. This can increase efficiency and/or performance.

The first and/or second antenna may exhibit coupling (in particular “crosstalk”), in particular due to their tuning and/or adaptation to the same frequency (UWB). Here, the at least one decoupling slot can be designed to reduce the coupling between the first and second antenna and/or to the ground plane. Preferably, the first and second antenna have at least one of the following features:
a coupling of less than −20 dB,
a reflection factor (also S11) of better (in particular less) than −10 dB,
omnidirectional radiation behavior with antenna gain greater than or equal to −10 dBi,
an efficiency greater than or equal to 65%,
a sensitivity sufficient to detect even small living beings, in particular newborns, during receiving, in particular by receiving reflections.

Here, the at least one decoupling slot can be arranged in the lower conductor structure and, in particular, have an at least partial (material) separation between the ring structure and the ground plane. Here, the decoupling can be increased by increasing the distance. Here, the decoupling slot can be designed to be rectangular, at least in sections, which makes it quick and/or easy to manufacture.

It is also conceivable that the first antenna and/or second antenna is designed as an omnidirectional antenna.

This can enable improved recognizing of living beings inside the vehicle, in particular compared to directional antennas (see also above). In particular, this makes it easier to detect multiple reflections traveling along different paths and in different directions.

In the context of the invention, it is optionally possible for the first antenna to have at least one of the following features:
a first terminal for driving, in particular by a control unit, which is arranged in the lower conductor structure and is connected in particular to a ground plane,
a second terminal for driving, in particular by a control unit, which is arranged in the upper conductor structure,
a first ellipse which is arranged in the lower conductor structure and, in particular, is electrically connected to a second ellipse via one or more connections,
a second ellipse which is arranged in the upper conductor structure and, in particular, is electrically connected to a first ellipse via one or more connections.

In order to reduce the electrical losses in the printed circuit board, the two ellipses can preferably be connected to one another via several connections. This allows the space between the ellipses to be kept approximately field-free.

Here, the first terminal can comprise a contacting with a ground plane. For example, it is conceivable that a sheath of a coaxial cable, which is used to connect to other components, e.g. the control unit, is connected (electrically and/or mechanically) to the first terminal.

Here, the second terminal can be configured to enable transmitting and/or receiving, in particular by (electrically) feeding in and/or tapping a transmit and/or receive signal. For example, the inner conductor of a coaxial cable can be connected to the second terminal. Preferably, the control unit is connected to the second terminal, in particular for data transmission.

Here, the first antenna can be designed as a monopole antenna, in particular due to the arrangement of the first and second ellipses. The first and second ellipses are preferably congruent, in particular in a plan view (e.g. perpendicular to the upper conductor structure, lower conductor structure and/or printed circuit board). In particular, the first and second ellipses can lie above or below one another, and in particular have substantially identical dimensions perpendicular to the printed circuit board. This can result in a particularly advantageous radiation characteristic. Here, a first and/or second ellipse can be (comparatively) easy to manufacture, for example in a printed circuit board (PCB) manufacturing process. Here, in particular, a connection can have one or more electrical and/or mechanical connection(s), preferably via(s). In this way, an equal (electrical) potential can be achieved between the two ellipses.

Furthermore, it may be provided within the context of the invention that the second antenna has at least one of the following features:
a first terminal for driving, in particular by a control unit, which is arranged in the lower conductor structure and is connected in particular to a ground plane,
a second terminal for driving, in particular by a control unit, which is arranged in the upper conductor structure,
a ring structure, which is arranged in the lower conductor structure,
an excitation structure, in particular an L-structure, which is arranged in the upper conductor structure, and in particular is arranged above a ring structure of the lower conductor structure.

Here, the first terminal can comprise a contacting with a ground plane. For example, it is conceivable that a sheath of a coaxial cable, which is used to connect to other components, e.g. the control unit, is connected (electrically and/or mechanically) to the first terminal.

Here, the second terminal can be configured to enable transmitting and/or receiving, in particular by (electrically) feeding in and/or tapping a transmit and/or receive signal. For example, the inner conductor of a coaxial cable can be connected to the second terminal. Preferably, the control unit is connected to the second terminal, in particular for data transmission.

Here, the second antenna can preferably be designed as a circularly polarized antenna, in particular due to the arrangement and/or geometric design in the lower and/or upper conductor structure.

Here, the second antenna can have a ring structure, which in particular is arranged in the lower conductor structure. Here, it is possible that a circle in the conductive layer of the lower conductor structure is cut out, e.g. by milling or etching during PCB production. A (circular) hole can therefore be created, around which the ring structure in particular is arranged. This can create an (electrically conductive) ring. Here, the hole can preferably have a diameter that is selected depending on the frequency of the ultra-wideband waves. Here, the hole can have a diameter of between 1 mm to 256 mm, in particular between 8 mm to 96 mm, preferably between 16 mm to 48 mm, preferably between 32 mm to 46 mm, particularly preferably between 36 mm to 42 mm, ideally between 38 mm to 40 mm. For example, a frequency between 7.25 GHz to 8.25 GHz (in particular in air) can result in a wavelength of 36 mm to 42 mm. Preferably, a circumference and/or diameter of the hole can substantially correspond to the wavelength. Here, the hole can also have a diameter of between 1 mm to 128 mm, in particular between 4 mm to 64 mm, preferably between 7 mm to 21 mm, preferably between 9 mm to 19 mm, particularly preferably between 11 mm to 17 mm, ideally between 13 mm to 15 mm. Here, simulations can result in an optimized compromise between (small) size and good transmit/receive properties at 14.5 mm.

The outer circumference of the ring structure can also be round in design. It may also be provided that the outer circumference of the ring structure is rectangular, in particular square, which can advantageously enable simple production. Preferably, the ring structure can be connected, in particular via a first terminal, to a ground plane of the lower conductor structure, and preferably to a ground plane of the control unit. Here, the ground plane can have an (electrically) conductive lamination, in particular in sections, for example the lamination (e.g. comprising copper) of a printed circuit board.

The second antenna may have an excitation structure, in particular an L-structure (L-shaped), which is arranged in the upper conductor structure and in particular is arranged above a ring structure, in particular above a hole thereof. As a result, they can be arranged substantially on top of one another, in particular in a plan view. This can result in a particularly advantageous radiation characteristic. The geometric design of the excitation structure, in particular the L-structure, in particular in combination with the ring structure, can result in an advantageous radiation characteristic. This can also preferably result in a circular polarization of the second antenna.

The ground plane of the lower and the upper conductor structure can preferably be connected (electrically and/or mechanically), for example by at least one, preferably a plurality of, via(s). Said via can be easy to manufacture and/or enable the same electrical potential. Preferably, such a connection can be easy to manufacture, for example in a printed circuit board (PCB) manufacturing process.

It may be provided that at least one second excitation structure, in particular L-structure, which is arranged in the upper conductor structure adjacent to the first excitation structure, in particular L-structure, is provided. This means that several second antennas can be provided and, in particular, can be easily produced (e.g. PCB manufacture).

It may be provided that at least one second ring structure is provided, which is arranged in the lower conductor structure adjacent to the first ring structure. This means that several second antennas can be provided and, in particular, can be easily produced (e.g. PCB manufacture). Here, the at least second ring structure and/or excitation structure (L-structure) can be designed and/or used at least partially as shown above (e.g. as part of the method below).

With respect to the present invention, it is conceivable that the lower conductor structure and the upper conductor structure are formed as lower and upper layers of a printed circuit board and/or that the lower conductor structure and the upper conductor structure are arranged substantially parallel to one another.

The parallel arrangement advantageously reduces the (effective) dielectric losses of the printed circuit board, in particular of the substrate.

Preferably, a (multilayer) printed circuit board can be used here, in particular with two electrically conductive layers (“lamination”), wherein in particular an upper conductor structure can be produced from an upper (outer) layer and/or a lower conductor structure can be produced on a lower (outer) layer, e.g. by a PCB manufacturing process. It may be provided that a substrate is arranged therebetween. Here, a substrate can be located between the upper and lower conductor structure. Said substrate can preferably be insulating. It can include FR4, for example. A substrate with comparatively higher absorption, higher dielectric constant and/or lower costs can be used particularly advantageously due to the geometric design. For example, in particular in comparison to higher frequencies such as at about 60 GHz, materials such as FR4 can be used instead of materials with better high-frequency properties such as a lower dielectric constant, which are in particular more expensive.

Here, the distance between the lower and upper conductor structure, which are preferably conductive (for example by having copper), can be between 0.0001 mm to 1000 mm, in particular between 0.001 mm to 100 mm, preferably between 0.01 mm to 10 mm, preferably between 0.1 mm to 5.0 mm, particularly preferably between 0.5 mm to 2.5 mm, ideally between 1.4 mm to 1.6 mm. This can result in an advantageous ratio between mechanical robustness and low costs and/or weight or installation space.

Alternatively or additionally, (at least) one (or two) central conductor structures may be provided. Said central conductor structure can be arranged between the upper and lower conductor structure, for example in the middle. It can therefore be a three-layer (or four-layer) printed circuit board. Here, the central conductor structure can preferably be identical to the lower conductor structure. The first and/or second antenna, or the corresponding components of the lower conductor structure, may therefore be copied or be substantially identical in design. Particularly preferably, the central conductor structure has a ring structure and/or a hole which are arranged congruently with the ring structure and/or the hole of the lower conductor structure. This can advantageously lead to an improved (second) antenna. In particular, this can result in better excitation of and by circularly polarized ultra-wideband waves. The efficiency and/or sensitivity of the (second) antenna can be increased. Here, it may be provided that the lower or central conductor structure has a first and/or second terminal. It may be provided that by using a central conductor structure, in particular in interaction with the lower and/or upper conductor structure, a direction of an incident ultra-wideband wave, in particular during receiving, can be determined. This can improve the accuracy with which a living being is recognized. In particular, a more precise resolution of the position of one (or more) living beings in the vehicle interior can be made possible.

The above object is further achieved according to a second aspect by a method according to the invention for recognizing living beings, in particular persons and/or children, in a vehicle interior of a vehicle, comprising:
providing a device according to any of the preceding claims,
driving of the first antenna and/or second antenna by a control unit, wherein the first antenna and/or second antenna carries out transmitting of ultra-wideband waves, in particular in the vehicle interior,
driving the first antenna and/or second antenna by the control unit, wherein the first antenna and/or second antenna carries out receiving of at least one reflection of the ultra-wideband waves to provide a receive signal,
detecting of the receive signal by the control unit,
determining a movement frequency, in particular respiration frequency, depending on the receive signal in order to determine the presence of a living being in the vehicle interior, outputting output information depending on the determining.

This can be a computer-implemented method. Here, the method can be carried out at least partially by a computer and/or a control unit.

Here, the actions or features can be carried out in the sequence shown, in particular repeatedly. This enables constant detection of living beings. In particular, it is possible to determine whether a living creature is present, for example in the interior of the vehicle. It can also be determined whether it has already left the vehicle. Preferably, the method can be used during and/or after locking and/or unlocking the vehicle, for example a door or flap. This means that before parking and/or leaving the vehicle, for example overnight, it can be ensured that there are no more living beings in the vehicle interior.

The providing may comprise installing and/or commissioning the device according to the first aspect, for example in a vehicle, in particular in a vehicle interior of the vehicle.

Here, driving, in particular for transmitting, of the first and/or second antenna can be carried out by a control unit (see below). The first and/or second antenna can then transmit ultra-wideband waves. Said ultra-wideband waves can be at least partially reflected and/or absorbed in the vehicle interior and/or by a living being inside. Depending on the presence of a living being, the (reflected) ultra-wideband waves can change. In particular, a movement frequency of the living being, in particular the respiratory frequency and/or the raising or lowering of the chest, can be imprinted (e.g. modulated) onto the (reflected) ultra-wideband waves.

Here, driving, in particular for receiving, of the first and/or second antenna can be carried out by a control unit (see below). The first and/or second antenna can then receive (reflected) ultra-wideband waves. Said ultra-wideband waves may have been at least partially reflected in the vehicle interior and/or on a living being inside. Depending on the presence of a living being, the (reflected) ultra-wideband waves may have changed, which advantageously affects the course and/or frequencies of the receive signal. In particular, a movement frequency of the living being, in particular the respiratory frequency and/or the raising or lowering of the chest, can have an effect on the (reflected) ultra-wideband waves and thus on the receive signal.

The receive signal can be provided depending on the receiving. The receive signal can be detected by the control unit, in particular in order to subsequently further process the receive signal.

Here, determining can be carried out by the control unit. Here, a movement frequency can be determined depending on the receive signal. This can be done, for example, by a Fourier transformation. It may also be provided to use pre-trained algorithms and/or pattern recognition in the control unit to advantageously determine a movement frequency.

Here, determining can comprise classifying a living being. Here, classifying, in particular depending on the movement frequency, can comprise assigning the living being to at least one of the following categories:
animal,
human,
adult,
senior,
child,
toddler,
newborn baby.

Here, the output (see below) can be dependent on determining, in particular the (result of) classifying.

It may be particularly preferred if the determining uses, incorporates, comprises and/or incorporates further information. It is therefore conceivable to use additional sensors in a seat, wherein it can be determined, e.g. depending on a weight and/or pressure on the seat, whether there is a living being on it. By combining the information, improved and/or more reliable recognition can be made possible. Further information can also be provided by temperature sensors, for example an infrared sensor. Alternatively or additionally, it is conceivable to use at least one microphone to provide a sensor signal. This allows noises from the vehicle interior to be detected and, in particular, depending on external noise (e.g. from an additional microphone), a recognition to be carried out and/or improved.

Here, outputting output information can be carried out depending on determining, in particular by the control unit. This may have one of the following features, in particular when a living being is recognized in the vehicle:
locking the locking mechanism of one or all moving parts of the vehicle, such as a door or flap,
visual (e.g. flashing, turning up the headlights) and/or acoustic warning (e.g. honking), in particular of the vehicle owner and/or vehicle operator,
sending an emergency call.
opening one or all moving parts of the vehicle, such as a door or flap.

This can preferably increase safety. In particular, it can be ensured that no living being is forgotten in the vehicle interior.

This results in the same advantages with respect to a method according to the invention as have already been described with respect to a device according to the invention according to the first aspect.

Further, it is conceivable that the driving comprises a driving of the first antenna, wherein the first antenna carries out transmitting of ultra-wideband waves, and the driving comprises a driving of the second antenna, wherein the second antenna carries out receiving of at least one reflection of the ultra-wideband waves, and/or that the driving comprises a driving of the second antenna, wherein the second antenna carries out transmitting of ultra-wideband waves, and the driving comprises a driving of the first antenna, wherein the first antenna carries out receiving of at least one reflection of the ultra-wideband waves. This can also be referred to as monostatic operation.

It is further conceivable that two devices 100 are used, of which the first device transmits the UWB signal on one or both antennas and the second device receives the reflected UWB signals on one, the other or both antennas. This can be described as bistatic operation.

In other words, transmitting and receiving can take place at different times. In particular, it is possible to transmit first and then receive. It may be provided that only the first or second antenna transmits (or is driven to do so) and then the second or first antenna receives (or is driven to do so). This can be carried out alternately and/or repeatedly. This allows a particularly good synergy to be created between the two antennas. It may be particularly preferable to transmit with the first antenna, in particular with linear polarization, and (subsequently) receive with the circularly polarized second antenna. This allows the receive level to be maximized and/or the (comparatively) largest proportion of reflected ultra-wideband waves to be received.

Alternatively or additionally, it may be provided to carry out transmitting and receiving with the first antenna. Advantageously, this enables emergency operation if the second antenna is defective.

Alternatively or additionally, it may be provided to carry out transmitting and receiving with the second antenna. Advantageously, this enables emergency operation if the first antenna is defective.

The above object is further achieved according to a third aspect by a computer program product according to the invention, comprising instructions which, when the computer program product is executed by a computer, cause the computer to implement the method according to the second aspect.

This results in the same advantages with respect to a computer program product according to the invention as have already been described with respect to a device according to the invention according to the first aspect and/or a method according to the invention according to the second aspect.

The above object is further achieved according to a fourth aspect by a computer-readable data carrier in which instructions are stored which, when executed by a computer, cause the computer to carry out the method according to the second aspect.

This results in the same advantages with respect to a computer-readable data carrier according to the invention as have already been described with respect to a device according to the invention according to the first aspect and/or a method according to the invention according to the second aspect and/or a computer program product according to the invention according to the third aspect.

The above object is further achieved according to a fifth aspect by a control unit comprising a computing unit and a memory unit in which instructions are stored which, when at least partially executed by the computing unit, carry out a method according to the second aspect.

The control unit can have and/or drive transmit amplifiers and/or receive amplifiers. The first antenna, the second antenna and/or the control unit can have a transmit/receive duplexer in order to enable switching between transmitting and receiving, in particular for the first antenna and/or second antenna.

Here, the control unit may have at least one of the following features:
a first transmit/receive channel, in particular comprising a transmit/receive duplexer for switching between transmitting and receiving, which is preferably connected to a first antenna, in particular via the second terminal of the first antenna,
a second transmit/receive channel, in particular comprising a transmit/receive duplexer for switching between transmitting and receiving, which is preferably connected to a second antenna, in particular via the second terminal of the second antenna,
a first terminal for connecting the control unit to the first antenna,
a second terminal for connecting the control unit to the second antenna.

Here, the control unit can be connected to the ground plane. Preferably, the control unit can also be designed at least partially as a printed circuit board and/or in the printed circuit board.

This results in the same advantages with respect to a control unit according to the invention as have already been described with respect to a device according to the invention according to the first aspect and/or a method according to the invention according to the second aspect and/or a computer program product according to the invention according to the third aspect and/or a computer-readable data carrier according to the invention according to the fourth aspect.

The above object is further achieved according to a sixth aspect by a vehicle according to the invention comprising a control unit according to the fifth aspect and/or a device according to the first aspect, wherein in particular the device is arranged in a vehicle roof, a headrest, a backrest and/or a door of the vehicle.

Here, at least one device may be provided, preferably at least two devices, preferably at least three devices, in particular at least four devices, ideally at least five devices. Here, a larger number can allow more accurate detection. Here, a smaller number can optimize costs, weight, effort, increased comfort and/or better transparency (e.g. of the vehicle roof which can be designed with glass instead of opaque parts of the device).

The (at least one) device can be arranged at at least one of the following positions in or on the vehicle:
in or on a vehicle roof (in particular for optimized illumination),
a headrest,
a (top edge of a) backrest,
a door and/or flap, in particular at parapet height.

Here, the combination of different positions can increase robustness and/or reliability.

This results in the same advantages with respect to a vehicle according to the invention as have already been described with respect to a device according to the invention according to the first aspect and/or a method according to the invention according to the second aspect and/or a computer program product according to the invention according to the third aspect and/or a computer-readable data carrier according to the invention according to the fourth aspect and/or a control unit according to the invention according to the fifth aspect.

### BRIEF DESCRIPTION OF THE DRAWINGS

Further advantages, features and details of the invention are apparent from the following description, in which several embodiments of the invention are described in detail with reference to the drawings. Here, the features mentioned in the claims and in the description can each be essential to the invention individually or in any combination. In the figures:

FIG. 1 shows a device 100, in particular an upper conductor structure 40;

FIG. 2 shows a device 100, in particular a lower conductor structure 30;

FIG. 3 shows a top view of a device 100 on a printed circuit board 50;

FIG. 4 shows a vehicle 200; and

FIG. 5 shows a method.

In the foregoing figures, the same technical features, including those of different embodiment examples, are represented by identical reference signs.

### DETAILED DESCRIPTION OF THE CURRENT EMBODIMENTS

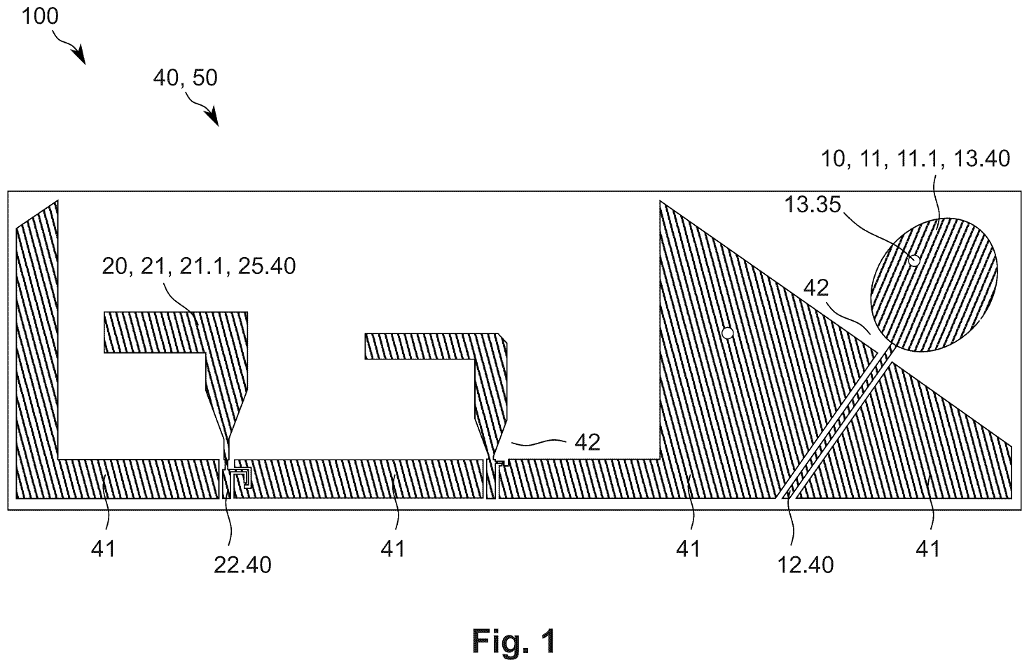

FIG. 1 shows a device 100 for recognizing living beings, in particular persons and/or children, in a vehicle interior 201 of a vehicle 200, having:
a first antenna 10 for transmitting 121, 121.1, 121.2 and/or receiving 131, 131.1, 131.2 ultra-wideband waves,
a second antenna 20 for transmitting 121, 121.1, 121.2 and/or receiving 131, 131.1, 131.2 ultra-wideband waves,
an upper conductor structure 40, wherein the first antenna 10 and the second antenna 20 are arranged at least partially in the upper conductor structure 40.

Here, the upper conductor structure 40 is in particular surrounded by a printed circuit board 50 and in particular forms a surface thereof. The upper conductor structure 40 can be manufactured in a lamination of a printed circuit board 50, for example by milling or in another PCB manufacturing process.

Here, the first antenna 10 comprises a first polarization 11, which in particular has a linear polarization 11.1. Said linear polarization can result from the geometric design as a second ellipse 13.40 in the upper conductor structure 40. The second ellipse 13.40 is connected to a first ellipse 13.30 in a lower conductor structure 30 via a connection 13.35. The second ellipse 13.40 can be spaced and/or separated from the ground plane 41 by a decoupling slot 42. A transmitting and/or receiving, in particular a transmit and/or receive signal, can be transferred to or from the first antenna 10 via a second terminal 12.40.

Here, the second antenna 20 comprises a second polarization 21, which in particular has a circular polarization 21.1. Said circular polarization can result from the geometric design as excitation structure 25.40, in particular L-structure 25.40, in the upper conductor structure 40. The excitation structure 25.40, in particular L-structure 25.40, is preferably isolated from the ground plane 41 and/or the ring structure 24.30. The excitation structure 25.40, in particular L-structure 25.40, can be spaced and/or separated from the ground plane 41 via a decoupling slot 42. Via a second terminal 22.40 connected to the excitation structure 25.40, in particular L-structure 25.40, transmitting and/or receiving, in particular a transmit and/or receive signal, can be transferred to or from the second antenna 20. Also shown is an optional second excitation structure 25.40, in particular L-structure 25.40.

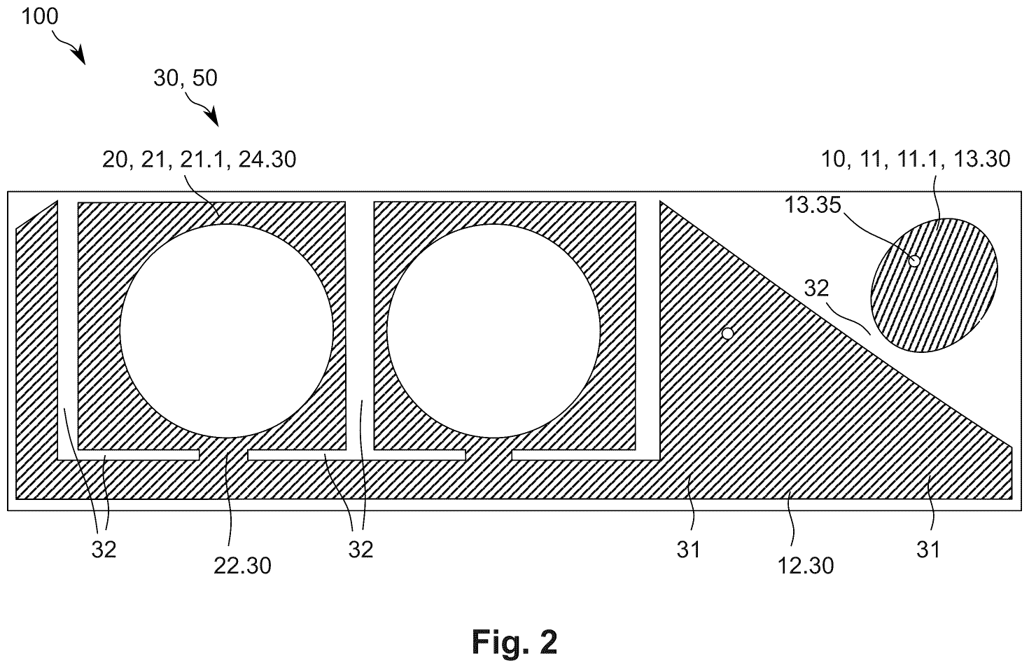

FIG. 2 shows a device 100 for recognizing living beings, in particular persons and/or children, in a vehicle interior 201 of a vehicle 200, having:
a first antenna 10 for transmitting 121, 121.1, 121.2 and/or receiving 131, 131.1, 131.2 ultra-wideband waves,
a second antenna 20 for transmitting 121, 121.1, 121.2 and/or receiving 131, 131.1, 131.2 ultra-wideband waves,
a lower conductor structure 30, wherein the first antenna 10 and the second antenna 20 are arranged at least partially in the lower conductor structure 30.

Here, the lower conductor structure 30 is in particular surrounded by a printed circuit board 50 and in particular forms a surface thereof. The lower conductor structure 30 can be manufactured in a lamination of a printed circuit board 50, for example by milling or in another PCB manufacturing process.

Here, the first antenna 10 comprises a first polarization 11, which in particular has a linear polarization 11.1. Said linear polarization can result from the geometric design as a first ellipse 13.30 in the lower conductor structure 30. The first ellipse 13.30 is connected to a second ellipse 13.40 in an upper conductor structure 40 via a connection 13.35. The first ellipse 13.30 can be spaced and/or separated from the ground plane 31 by a decoupling slot 32. A transmitting and/or receiving, in particular a transmit and/or receive signal 132, can be transferred to or from the first antenna 10 via a first terminal 12.30. Here, in particular, the ground can be connected via the first terminal 12.30.

Here, the second antenna 20 comprises a second polarization 21, which in particular has a circular polarization 21.1. Said circular polarization can result from the geometric design as a ring structure 24.30 in the lower conductor structure 30. The ring structure 24.30 is preferably connected to the ground plane 41, in particular via a first terminal 22.30. The ring structure 24.30 can be spaced and/or separated from the ground plane 31 by a decoupling slot 32. A transmitting and/or receiving, in particular a transmit and/or receive signal 132, can be transferred to or from the first antenna 20 via a first terminal 22.30. Here, in particular, the ground can be connected via the first terminal 22.30. Also shown is an optional second ring structure 24.30.

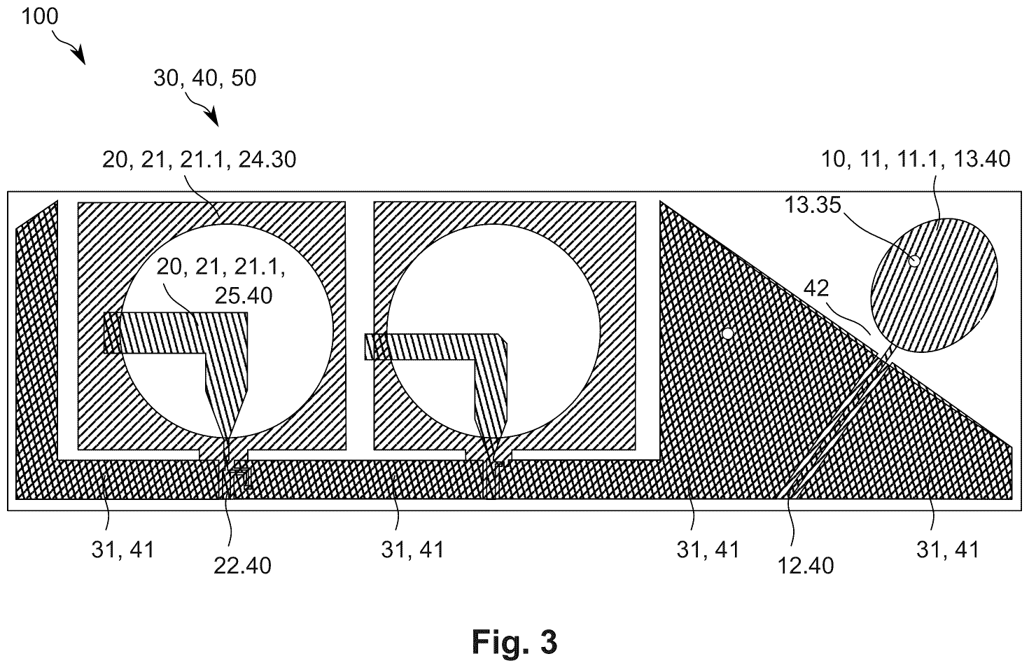

FIG. 3 shows a top view of a printed circuit board 50 based on FIG. 1 and FIG. 2.

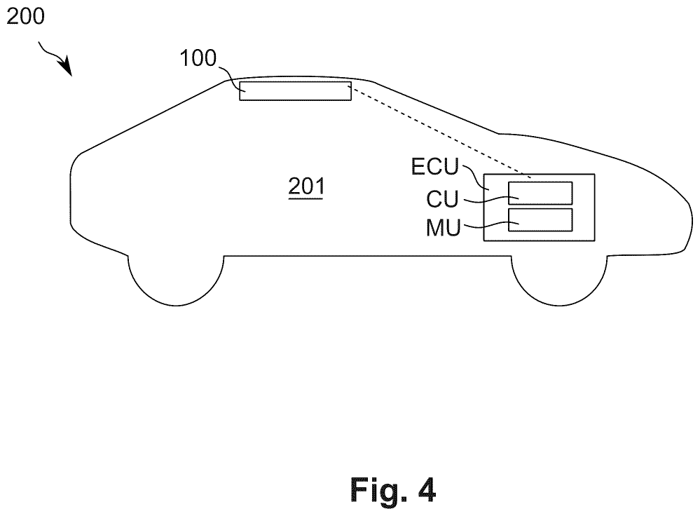

FIG. 4 shows a vehicle 200 comprising a control unit ECU according to the preceding claim and/or a device 100 according to any of the preceding claims, wherein in particular the device 100 is arranged in a vehicle roof, a headrest, a backrest, and/or a door of the vehicle 200. A control unit ECU, having a computing unit CU and a memory unit MU, in which instructions are stored which, when at least partially executed by the computing unit CU, carry out a method, may here be comprised in the vehicle 200.

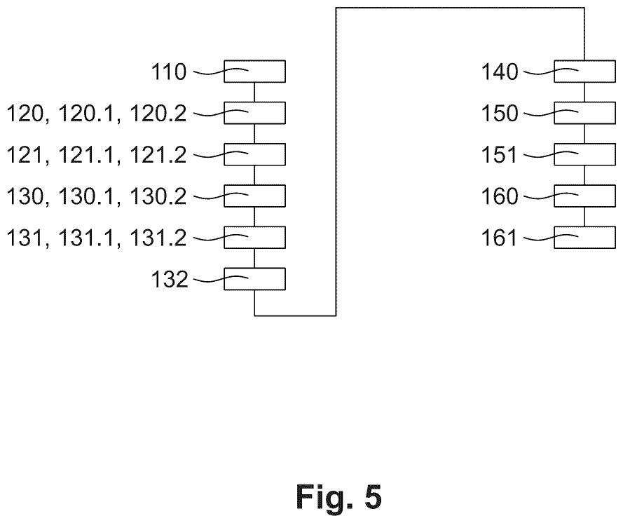

FIG. 5 shows a method for recognizing living beings, in particular persons and/or children, in a vehicle interior 201 of a vehicle 200, comprising:
providing 110 a device 100 according to any of the preceding claims,
driving 120, 120.1, 120.2 of the first antenna 10 and/or second antenna 20 by a control unit ECU, as a result of which the first antenna 10 and/or second antenna 20 carries out transmitting 121, 121.1, 121.2 of ultra-wideband waves, in particular in the vehicle interior 201,
driving 130, 130.1, 130.2 the first antenna 10 and/or second antenna 20 by the control unit ECU, as a result of which the first antenna 10 and/or second antenna 20 carries out receiving 131, 131.1, 131.2 of at least one reflection of the ultra-wideband waves to provide a receive signal 132,
detecting 140 of the receive signal 132 by the control unit ECU,
determining 150 a movement frequency 151, in particular respiration frequency 151, depending on the receive signal 132 in order to determine the presence of a living being in the vehicle interior 201 of the vehicle 200,
outputting 160 output information 161 depending on the determining 150.

### List of Reference Numerals

10 first antenna
11 first polarization
11.1 linear polarization
12.30 first terminal
12.40 second terminal
13.30 first ellipse
13.40 second ellipse
13.35 connection
20 second antenna
21 second polarization
21.1 circular polarization
22.30 first terminal
22.40 second terminal
24.30 ring structure
25.40 excitation structure, L-structure
30 lower conductor structure
31 ground plane
32 decoupling slot
40 upper conductor structure
41 ground plane
42 decoupling slot
50 printed circuit board
100 device
110 providing
120 driving
120.1 driving the first antenna
120.2 driving the second antenna
121 transmitting
121.1 transmission of the first antenna
121.2 transmission of the second antenna
130 driving
130.1 driving the first antenna
130.2 driving the second antenna
131 receiving
131.1 receiving of the first antenna
131.2 receiving of the second antenna
132 receive signal
140 detecting the receive signal
150 determining a movement frequency
151 movement frequency, respiration frequency
160 outputting output information
161 output information
200 vehicle
201 vehicle interior
ECU control unit
CU computing unit
MU memory unit

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A device for recognizing persons or children in a vehicle interior, comprising:
a first antenna for transmitting or receiving ultra-wideband waves;
a second antenna for transmitting or receiving ultra-wideband waves;
a lower conductor structure, wherein the first antenna and the second antenna are arranged at least partially in the lower conductor structure; and
an upper conductor structure, wherein the first antenna and the second antenna are arranged at least partially in the upper conductor structure.

2. The device of claim 1, wherein the first antenna has a first polarization and the second antenna has a second polarization, wherein the first polarization and the second polarization differ at least in part.

3. The device of claim 1, wherein the first antenna has a first polarization comprising a linear polarization or the second antenna has a second polarization comprising a circular polarization.

4. The device of claim 1, wherein the first antenna or the second antenna is configured to transmit or receive at a frequency of between 1.0 GHz to 100.00 GHz.

5. The device of claim 1, wherein the lower conductor structure or the upper conductor structure includes at least one decoupling slot to decouple the first antenna, the second antenna, or a ground plane.

6. The device of claim 1, wherein at least one of the first antenna and the second antenna comprises an omnidirectional antenna.

7. The device of claim 1, wherein the first antenna comprises:
a first terminal arranged in the lower conductor structure and connected to a ground plane;
a second terminal arranged in the upper conductor structure;
a first ellipse arranged in the lower conductor structure; and
a second ellipse arranged on the upper conductor and electrically connected to the first ellipse via one or more connections.

8. The device of claim 1, wherein the second antenna comprises:
a first terminal arranged in the lower conductor structure and connected to a ground plane;
a second terminal arranged in the upper conductor structure;
a ring structure is arranged in the lower conductor structure; and
an excitation structure arranged in the upper conductor structure and arranged above the ring structure.

9. The device of claim 1, wherein:
the lower conductor structure and the upper structure are formed as lower and upper layers of a printed circuit board; and
the lower conductor structure and the upper conductor structure are arranged substantially parallel to each other.

10. A method for recognizing persons or children in a vehicle interior, comprising:
providing the device according to claim 1;
driving the first antenna or the second antenna by an electronic control unit (ECU), such that the first antenna or the second antenna transmits ultra-wideband waves in the vehicle interior;
driving the first antenna or the second antenna by the ECU, such that the first antenna or the second antenna receives a reflection of the ultra-wideband waves to provide a received signal;
detecting the received signal by the ECU;
determining a movement frequency based on the received signal in order to detect a living being in the vehicle interior; and
outputting information in response to determining a movement frequency.

11. The method of claim 10, wherein:
the first antenna transmits the ultra-wideband waves; and
the second antenna receives the reflection of the ultra-wideband waves.

12. A computer program comprising instructions which, when the computer program is executed by a computer, cause the computer to implement the method according to claim 10.

13. A computer-readable data carrier in which instructions are stored which, when executed by a computer, cause the computer to implement the method according to claim 10.

14. An electronic control unit having a computing unit and a memory unit, the memory unit having computer-readable instructions that, when executed by the computing unit, cause the computing unit to implement the method of claim 10.

15. A vehicle comprising the device according to claim 1, wherein the device is arranged in a roof, a headrest, a backrest, or a door of the vehicle.
